(19) United States
(12) Patent Application Publication
(10) Pub. No.: US 2002/0154147 A1
(43) Pub. Date: Oct. 24, 2002

(54) Photo ranking system for creating digital album pages

(76) Inventor: Amy E. Battles, Windsor, CO (US)

Correspondence Address: HEWLETT-PACKARD COMPANY, Intellectual Property Administration, P.O. Box 272400, Fort Collins, CO, 80527-2400, US

(21) Appl. No.: 09/838,972

(22) Filed: Apr. 20, 2001

(51) Int. Cl. G09G 5/00

(52) U.S. Cl. 345/660

(57) ABSTRACT

A user ranks photographic images by providing ranking information to an information handling system. Each photographic image is tagged with the rank selected by the user, and sized based on its ranking. In this way, photographic images ranked higher by the user may be sized larger than photographic images ranked lower. The sized photographic images may then be saved in an album file or other data file, or printed out, or both.

### FIELD OF THE INVENTION

This invention relates to photography, and more particularly to organizing and displaying photographic images.

### BACKGROUND

Many people who take photographs to capture memories of their family, friends and activities have boxes of those photographs stored in a closet or in the attic. They often wish to put those photographs into photo albums for easier viewing, but often put it off due to the need to purchase photo albums, then sort through photos and place them into the albums. Meanwhile, the number of photographs in their possession continues to grow, making it even more difficult to organize those photographs into albums.

In the world of digital photography, this problem still exists. Instead of boxes, users have hard drives fill of photos they have taken with digital cameras or scanned from photographic prints. They often wish to print these photos onto paper or organize them into web pages or album files for easier viewing. Software is available to help create digital album pages on a computer, such as Hewlett Packard's Print Creator and Microsoft's Picture It!. In such software packages, a user can easily select and place photographic images into pre-made album page templates, then save the completed album page and/or print it. While this process may be faster and easier than putting physical photographs one-by-one into a traditional photo album, it still requires a dedicated session at the computer. As a result, the process is still time-consuming enough that users often put it off indefinitely.

An alternate solution is provided by Hewlett Packard's PhotoSmart P1000 and P1100 photo printers. These printers have a memory card slot for receiving a memory card from a digital camera, and an option to automatically print album pages at the touch of a button. As a result, the user need not sit down at a computer and manually arrange photographs into album page templates. However, this feature does not allow the user to control the layout of the photographs. All of the photographs are the same size, and are arranged in a grid pattern on each album page in chronological order.

### SUMMARY

A user ranks photographic images, which are then sized based on the selected ranking and placed onto an album page.

In one aspect of the invention, a user ranks photographic images by providing ranking information to an information handling system. The user may select one of a number of discrete rankings for each photographic image, based on criteria such as the subjective value to the user of each photographic image. Each photographic image is tagged with the rank selected by the user.

In another aspect of the invention, each photographic image is sized based on its ranking. In this way, photographic images ranked higher by the user may be sized larger than photographic images ranked lower. The sized photographic images may then be saved in an album file or other data file, or printed out, or both. In this way, album pages can be created in which photographic images that the user values more are displayed at a larger size than photographic images that the user values less.

The invention will be more fully understood upon consideration of the detailed description below, taken together with the accompanying drawings.

### BRIEF DESCRIPTION OF THE DRAWINGS

FIG. 1 is a block diagram of an information handling system.

FIG. 2 is a flow chart of an embodiment of the inventive method.

FIG. 3 is a block diagram of photographic data.

Use of the same reference symbols in different figures indicates similar or identical items.

### DETAILED DESCRIPTION OF THE PREFERRED EMBODIMENTS

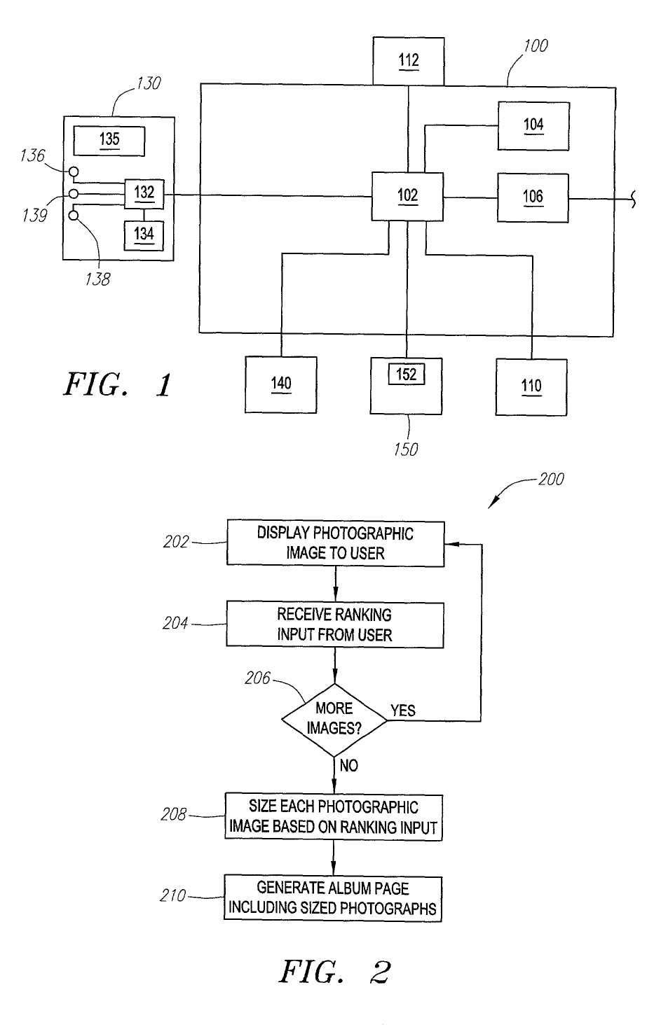

Referring to FIG. 1, an information handling system 100 is shown. The information handling system 100 may be a personal computer, Internet appliance, personal digital assistant, server, or any other device capable of handling and processing digital information. The information handling system 100 includes a processor 102, which may be a microprocessor, integrated circuit, field-programmable gate array (FPGA), or other electronic device adapted to control the information handling system 100. The processor 102 is electrically connected to a storage device 104, which may be a hard disk drive, a removable disk drive, an optical storage drive, a flash memory card, random-access memory (RAM), or any other device capable of storing data. The processor 102 may optionally be connected to a communications interface 106, such as a modem, wireless modem, cable modem, network interface card, or other device adapted to connect the information handling system 100 to an external communications network.

In one embodiment, the information handling system 100 is adapted to interface with one or more input devices 110, through which a user can provide input to the information handling system 100. The input device 110 may be a keyboard, mouse, trackball, or any other device capable of receiving input from a user. Several different input devices 110 may be connected to the information handling system 100 at the same time, such as a keyboard and a mouse. The connection of the input device 110 to the information handling system 100 is standard.

In one embodiment, the information handling system 100 is also adapted to interface with a display 112, through which information can be presented to a user. The display 112 may be a cathode ray tube, a liquid-crystal display (LCD), or any other device capable of displaying information to a user. The connection of the display 112 to the information handling system 100 is standard.

In one embodiment, the information handling system 100 is adapted to interface with a digital camera 130, wherein photographic image data is routed from the camera 130 to the storage unit 104 by the processor 102. In one embodiment, the camera 130 is connected to the information handling system 100 via a cable having a serial connector, which is attached to a matching serial connector on the information handling system 100. Other cable-based connectors and protocols may be used to connect the camera 130 to the information handling system 100, such as parallel, USB, or IEEE 1394 connectors and protocols. In another embodiment, the camera 130 is connected to the information handling system 100 via a wireless connection, such as an infrared connection. In such an embodiment, the information handling system 100 and the camera 130 include the appropriate wireless camera interface hardware (not shown) to enable the transmission of photographic image data between them. Both cable-based and wireless connections between a camera 130 and an information handling system 100 are standard to those having ordinary skill in the art.

The camera 130 includes a camera processor 132, which may be a microprocessor, integrated circuit, field-programmable gate array (FPGA), or other electronic device adapted to control the camera 130. The camera processor 132 is electrically connected to a camera storage device 134, which may be a hard disk drive, a removable disk drive, an optical storage drive, a flash memory card, random-access memory (RAM), or any other device capable of storing data. The camera processor 132 is also connected to a camera display 135, which may be an LCD screen or other device adapted to display information to a user. In one embodiment, photographic images captured by the camera 130 may be shown on the camera display 135. The use of the camera processor 132, camera storage device 134 and camera display 135 in a camera 130 is standard to those having ordinary skill in the art.

In one embodiment, the camera processor 132 is also electrically connected to a first ranking control 136 and a second ranking control 138. In another embodiment, only a single ranking control is provided. A selection control 139 also may be provided on the camera 130, and is electrically connected to the camera processor 132. The functions of the ranking controls 136, 138 and the selection control 139 are disclosed in greater detail below. The camera 130 need not be a dedicated digital camera, and instead may be a personal digital assistant or other portable information handling system capable of acquiring images.

The information handling system 100 additionally may be adapted, or alternatively may be adapted, to interface with a scanner 140. Photographic image data may be routed from the scanner 140 to the storage unit 104 by the processor 102. In one embodiment, the scanner 140 is connected to the information handling system 100 via a cable having a serial connector, which is attached to a matching serial connector on the information handling system 100. Other cable-based connectors and protocols maybe used to connect the camera 130 to the information handling system 100, such as parallel, USB, or IEEE 1394 connectors and protocols. In another embodiment, the scanner 140 is connected to the information handling system 100 via a wireless connection, such as an infrared connection. Both cable-based and wireless connections with an information handling system 100 are standard to those having ordinary skill in the art.

The information handling system 100 may be connected to a printer 150. The printer 150 maybe any type of printer capable of attachment to the information handling system 100, such as a laser printer or an ink cartridge printer. The connection between the information handling system 100 and the printer 150 is standard, and may be accomplished through a cable or via a wireless connection such as an infrared connection. The printer 150 may include a printer processor 152 that controls the operation of the printer 150. The printer processor 152 may be a microprocessor, integrated circuit, FPGA, or other appropriate electronic control device.

Referring as well to FIG. 2, a method 200 for creating digital photo album pages is shown. In block 202, a photographic image is displayed to a user by the information handling system 100. That photographic image may be contained in a window of a graphical user interface, may be sized to fit the display, or may be displayed in another way. The particular manner of display of the photographic image is not critical to the invention. In one embodiment, the photographic image has already been received into the storage unit 104 from the camera 130 or the scanner 140, and the processor 102 retrieves that photographic image from the storage unit 104 and displays it on the display 112. In another embodiment, the photographic image is displayed to the user on the display 112 as it is received into the information handling system 100 and the storage unit 104 from the camera 130 or the scanner 140. In one embodiment, the length of time the photographic image is displayed on the display 112 is under the control of the user via the input device 110. In this way, the user can view the photographic image as long as desired.

In another embodiment, a photographic image is displayed to the user via the camera display 135 on the camera 130. The camera 130 may be connected to or disconnected from the information handling system 100 while the photographic image is is displayed to a user through the camera display 135. The photographic image may be displayed to the user on the camera display 135 in the same manner as described above in which a photographic image is displayed on the display 112.

Next, in block 204, in one embodiment the processor 102 receives ranking information from the user for the photographic image displayed in block 202. As the user views a photographic image on the display 112, the user selects a rank for that image. In one embodiment, the user may select one of a number of discrete ranks. As used in this document, the term “discrete ranks” refers to a fixed number of ranking options provided to the user. As an example, five discrete ranks may be provided: poor, fair, good, better and best. As another example, three discrete ranks may be provided: best, average, and worst. In another embodiment, the user is not limited to discrete ranks, and instead may input a number or other criteria of the user's choice. As an example, no discrete ranks are provided to choose from, and the user enters the number “5.4” when prompted for ranking information. The number of ranks, and their description, are not critical to the invention. Default ranking may be provided, such that each image defaults to a particular rank such that the user need only actively select a rank for images considered to differ from the default rank. The default rank may be preset, or set by the user. The photographic image displayed in block 202 preferably remains on the display 112 in block 204. In one embodiment, ranking controls are provided in a toolbar, window, or other graphical form separated from the photographic image. In another embodiment, ranking controls are provided on a toolbar, toolbox, or other graphical form that is superimposed upon part of the photographic image. The particular form of the ranking controls is not critical to the invention. The user provides ranking information by selecting a ranking through the input device 110, such as a mouse or keyboard. The user may select a ranking in a number of ways. In one embodiment, the user utilizes a mouse to click on a graphical button or icon labeled with the desired ranking, such as “best”. In another embodiment, the user presses a numeric key on a keyboard to select a desired ranking, where each ranking is associated with a numeric key. In another embodiment, the user clicks on and drags a slider to a position associated with a particular ranking. In another embodiment, the user presses the tab key on a keyboard to move between ranking choices, and presses the return key to select a particular ranking.

In another embodiment, the user selects a ranking through the camera 130, not the information handling system 100. The camera 130 need not be connected to an information handling system 100. The camera processor 132 receives ranking information from the user for the photographic image displayed in block 202. As the user views a photographic image on the camera display 135, the user selects a rank for that image. In one embodiment, the user utilizes the ranking controls 136, 138 and the selection control 139 to do so. The ranking controls 136, 138 and the selection control 139 may be switches or other controls through which the user can select a desired rank. The photographic image displayed in block 202 preferably remains on the camera display 135 in block 204. In one embodiment, a graphical user interface is provided on the camera display 135, and a number of ranking choices are superimposed on a portion of the photographic image on the camera display. The user utilizes the ranking controls 136, 138 to navigate a cursor or a highlight through the ranking choices, then presses the selection control 139 to select a particular rank. In another embodiment, a number of LEDs are provided on the body of the camera 130, each LED corresponding to a particular rank, where only one LED is lit at a time. The ranking controls 136, 138 change which LED is lit, corresponding to the desired rank of the photographic image. The user then presses the selection control 139 to select a particular rank. In another embodiment, additional ranking controls are provided, allowing for navigation through a two-dimensional ranking menu displayed on the camera display 135.

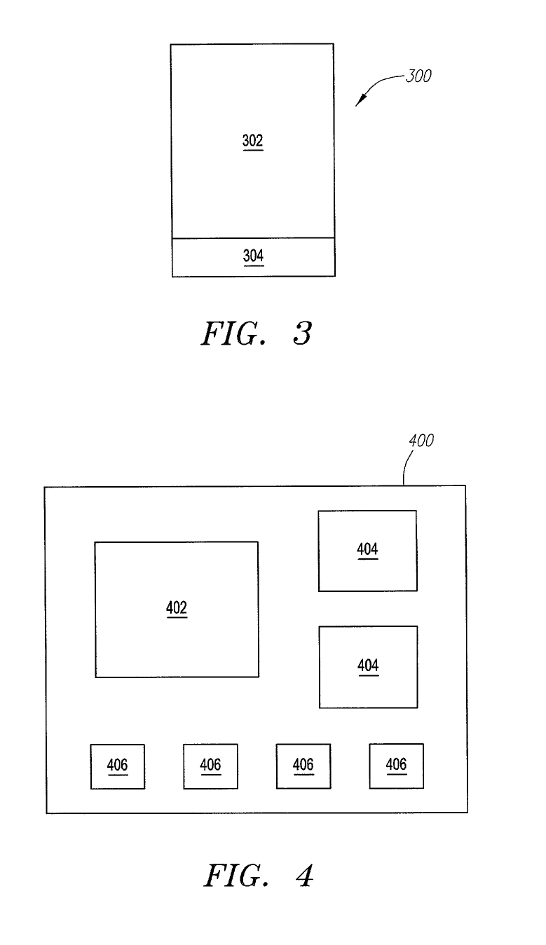

Referring as well to FIG. 3, each photographic image is preferably stored as digital image data 302, whether that image data 302 is stored in the storage device 104 or the camera storage device 134. The image data 302 may be stored in any format, such as in JPEG or GIF format. The storage of image data 302 is standard to one of ordinary skill in the art. When the processor 102 or the camera processor 132 (depending on the device used for ranking) receives ranking information for a photographic image represented by image data 302, it generates ranking data 304. The ranking data 304 is then associated with the image data 302, such as in a ranked image data block 300. As an example, ranking data 304 may be a data word having as many bits as ranking options, where the bit corresponding to a selected rank is set high, and the other bits are set low. Other formats and configurations of ranking data 304 may be utilized if desired. The ranked image data block 300 may be stored in the storage device 104 or the camera storage device 134. The image data 302 and the ranking data 304 need not be stored in a contiguous block, and may instead be stored in non-adjacent locations in the storage device 104 or the camera storage device 134. That is, the association between the image data 302 and the ranking data 304 is not based on the relative proximity of the data 302, 304 in a storage device 104, 134.

Referring again to FIG. 2, in block 206, if more photographic images remain for the user to rank, the method 200 returns to block 202. If there are no more photographic images for the user to rank, the method proceeds to block 208. The number of photographic images to be ranked by the user may be selected by the user, or may correspond to the number of photographic images stored in the camera storage device 134 or transmitted from the camera storage device 134 to the storage device 104. In another embodiment, a number of photographic images are stored, and they are automatically shown to the user until the user provides input in block 206 via the input device that he or she does not wish to rank more photographic images, or until all of the photographic images have been ranked. The number of photographic images ranked by the user may be established in another way, if desired.

In block 208, each photographic image represented by image data 302 is sized based on its corresponding ranking data 304. In one embodiment, ranked image data blocks 300 are transmitted to the printer 150 from the camera 130 or the information handling system 100. The printer processor 152 then sizes each image data item 302 based on its corresponding ranking data 304. As used in this document, “sizing” refers to determining the dimensions for a photographic image to be printed, and “image size” refers to the dimensions of a printed image. In one embodiment, a separate and discrete image size corresponds to each particular ranking available. For example, a large image size may correspond to a high ranking, and a small image size may correspond to a low ranking. In one embodiment, image data 302 corresponding to ranking data 304 having a value at or below a minimum value is sized to zero. That is, images ranged below a certain rank are ignored. As an example, image data 302 corresponding to ranking data 304 having a value of “poor” is sized to zero, so that image data 302 of poor quality is ignored and not printed. In one embodiment, the printer processor 152 includes or is connected to a lookup table in which the printer processor 152 looks up the image size corresponding to a particular item of ranking data 304.

In another embodiment, this sizing may be performed in the same manner by the processor 102 of the information handling system 100 or the camera processor 132 of the camera 130, rather than the printer processor 152. The results of this sizing may be transmitted to the printer 150, retained within the information handling system 100 or the camera 130, or both.

Next, in block 210, one or more album pages are generated, where each album page includes photographic images that have been sized in block 208. The album pages maybe printed via the printer 150, stored in the storage device 104 for viewing on the display 112, transmitted to a web server or web host via the communications interface 106 for insertion into a web page, or handled in another manner, if desired.

Referring to FIG. 4, an exemplary album page 400 is shown. The album page 400 includes a first image 402 having a first size, two smaller second images 404 each having a second size, and four still smaller images 406 each having a third size. Additional or different sizes of images may be included on the album page 400. The first image 402 has a first size larger than the other images 404, 406 on the page because of its ranking. That is, the first image 402 was sized in block 208 based on its corresponding ranking data 304, and the size corresponding to that ranking data 304 is the first size. The two second images 404 each have a second size smaller than the first size, also because of their ranking. That is, the second images 404 were sized in block 208 based on their corresponding ranking data 304, and the size corresponding to that ranking data is the second size. The four third images 406 each have a third size smaller than either the first size or the second size, also because of their ranking. That is, the third images 406 were sized in block 208 based on their corresponding ranking data, and the size corresponding to that ranking data is the third size.

The positioning of the images 402, 404, 406 on the album page 400 may be performed in a number of ways. In one embodiment, the images 402, 404, 406 are printed out on one or more album pages 400 in chronological or numerical order. In this embodiment, no particular optimization of image placement need be performed. In another embodiment, the images 402, 404, 406 are printed out in a manner that efficiently utilizes the space within one or more album pages 400, without adhering to a specific chronological or numerical order. As one example, the first image 402 having the largest size is placed in a particular location on the album page 400, such as the top left corner, and the size and shape of the remaining area is calculated. Next, if the remaining area is large enough, at least one image of the next smaller size is placed in that remaining area, and the size and shape of the remaining area is calculated. This iterative process continues until the remaining area is small enough that no additional images can be added, or until all of the available images have been placed on the album page 400. In another embodiment, the smaller images 406 are placed on the album page 400 first, and larger images are added later. In another embodiment, if multiple album pages 400 are generated, album page 400 generation switches between placing larger images first and smaller images first on the album page 400, in order to vary the layout across album pages 400. In another embodiment, multiple album pages 400 are created at a time, to optimize the layout of the images 402, 404, 406 across the album pages 400 and minimize wasted space. In another embodiment, a number of common album page 400 configurations are stored in the processor 102, the camera processor 132 or the printer processor 152, and one or more album pages 400 are generated using those stored configurations. That is, each configuration includes the locations and spacing of a number of images 402, 404, 406 of a given size on an album page 400, such that actual images can be inserted onto an album page 400 in the predetermined locations of a particular stored configuration. In another embodiment, images that are sized to zero in block 208 are not included on any album page 400. In this way, image data 302 that is undesirable, for example due to poor image quality, is not included in the album page 400. In another embodiment, each image 402, 404, 406 does not have a fixed image size corresponding to its ranking. Instead, each image 402, 404, 406 may, for example, have a fixed image size range corresponding to its ranking. As another example, the images 402, 404, 406 may have a defined image size relationship, such that each image 402, 404, 406 may be any size as long as higher-ranked images have a larger image size than lower-ranked images. In another embodiment, images 402, 404, 406 are assigned to album pages 400 in chronological or numerical order. Then, the images 402, 404, 406 on each album page 400 are arranged to optimize the usage of space on the album page 400. Other methods may be used to generate album pages.

After one or more album pages 400 are generated, they may be printed on the printer 150, stored in the storage device 104, or transmitted out of the information handling system 100 via the communications interface 106.

In another embodiment, blocks 208 and 210 are combined, such that individual album pages are completed one at a time. In such an embodiment, only the photographs appearing on a particular album page are sized before that album page is generated.

In one embodiment, the information handling system 100 is not used, and the camera 130 is connected directly to the printer 150, such as by a cable or a wireless infrared connection. In such an embodiment, blocks 202-206 preferably are performed by the camera 130, and blocks 208-210 preferably are performed by the printer 150. However, the performance of the blocks of the method 200 may be divided differently between the camera 130 and the printer 150 if desired.

Although the embodiments above have been described in terms of photographic image data, other types of image data may be handled in the same manner as described above for photographic image data.

Although the invention has been described with reference to particular embodiments, the description is only an example of the invention's application and should not be taken as a limitation. Consequently, various adaptations and combinations of features of the embodiments disclosed are within the scope of the invention as defined by the following claims and their legal equivalents.

What is claimed is:

1. A method for creating album pages for a user, comprising:
displaying an image to the user;
receiving information from the user for said image, said information comprising ranking information; and
sizing said image based on said ranking information.

2. The method of claim 1, further comprising generating an album page including said sized image.

3. The method of claim 2, further comprising printing said album page.

4. The method of claim 1, wherein said image is a photographic image.

5. The method of claim 1, wherein said image is stored as image data, further comprising storing said ranking information in association with said image data.

6. The method of claim 5, further comprising repeating said displaying and said receiving for a plurality of images, before said sizing.

7. The method of claim 6, wherein said sizing comprises sizing to zero all images associated with ranking information having a value less than a particular value.

8. The method of claim 7, further comprising generating an album page that excludes said images sized to zero.

9. The method of claim 1, wherein said ranking information has one of a plurality of discrete values.

10. The method of claim 9, wherein said sizing comprises selecting a discrete image size corresponding to said ranking information.

11. The method of claim 1, wherein said ranking information is received from a keyboard.

12. The method of claim 1, wherein said ranking information is received from a mouse.

13. The method of claim 1, wherein said ranking information is received from a selection control.

14. A method for creating album pages for a user, comprising:
displaying to the user a photographic image, said photographic image stored as image data;
receiving information from the user for said photographic image, said input comprising ranking information having one of a plurality of discrete values;
storing said ranking information in association with said image data;
repeating said displaying, receiving and storing steps for a plurality of photographic images;
sizing said photographic images by selecting a discrete image size corresponding to said ranking information;
generating at least one album page comprising said sized photographic images; and
printing said at least one album page.

15. A digital camera, comprising:
a camera processor;
a camera storage device electrically connected to said camera processor;
a camera display electrically connected to said camera processor; and
at least one ranking control electrically connected to said camera processor, whereby a user utilizes said ranking control to select a ranking for an image shown on said camera display.

16. The digital camera of claim 15, further comprising an enter control electrically connected to said camera processor.

17. The digital camera of claim 15, wherein said at least one ranking control controls a cursor on said camera display.

18. The digital camera of claim 15, wherein said at least one ranking control controls highlighting of a ranking option on said camera display.

19. A computer program product, comprising
instructions for displaying an image to the user;
instructions for receiving information from the user for said image, said information comprising ranking information; and
instructions for storing said ranking information in association with said image.

20. The computer program product of claim 19, further comprising instructions for sizing said image based on said ranking information.
